(19) United States
(12) Patent Application Publication
(10) Pub. No.: US 2004/0181812 A1
(43) Pub. Date: Sep. 16, 2004

(54) Prioritized communications

(76) Inventor: Peter G. Briggs, Duluth, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 10/387,607

(22) Filed: Mar. 13, 2003

(51) Int. Cl. H04N 7/173

(52) U.S. Cl. 725/131; 725/100; 725/111

(57) ABSTRACT

Systems and methods for implementing prioritized communications are provided. An embodiment of a method for implementing prioritized communications includes receiving a first message from a first set-top terminal (STT), receiving a second message from a second STT, the second message identifying a second communication priority for the second STT, and responding to the second message prior to responding to the first message, responsive to the communication priority identified by the second message.

### FIELD OF THE INVENTION

This invention relates in general to communication systems, and, more particularly, to prioritized communications.

### DESCRIPTION OF THE RELATED ART

Cable television systems are now capable of providing many services in addition to analog broadcast video. In implementing enhanced programming, set-top terminals (STTs), also known as set-top boxes, have become important computing devices for accessing various video services. In addition to supporting traditional analog broadcast video functionality, many STTs now also support an increasing number of two-way digital services such as, for example, video-on-demand.

An STT is typically connected to a subscriber television network (e.g., a cable or satellite television network) and includes hardware and software necessary to provide various services and functionality. Preferably, some of the software executed by an STT is downloaded and/or updated via the subscriber television network. Each STT also typically includes a processor, communication components and memory, and is connected to a television or other display device. While many conventional STTs are stand-alone devices that are externally connected to a television, an STT and/or its functionality may be integrated into a television or other device, as will be appreciated by those of ordinary skill in the art.

An STT may experience delays while communicating or attempting to communicate with a headend device. Such communication delays may be inconvenient to many users who expect continuous and uninterrupted service. Therefore, there exists a need for systems and methods for addressing these and/or other types of communication problems.

### BRIEF DESCRIPTION OF THE DRAWINGS

The invention can be better understood with reference to the following drawings. The components in the drawings are not necessarily drawn to scale, emphasis instead being placed upon clearly illustrating the principles of the present invention. In the drawings, like reference numerals designate corresponding parts throughout the several views.

FIG. 1 is a block diagram illustrating a communications system according to an embodiment of the present invention.

FIG. 2 is a simplified block diagram illustrating selected components of a headend according to an embodiment of the invention.

FIG. 3 is a block diagram depicting an STT according to an embodiment of the present invention.

FIG. 4 is a flow chart depicting a method for initializing an STT such that the STT is capable of operating in a DAVIC mode, according to an embodiment of the present invention.

FIG. 5 is a flow chart depicting a method for implementing prioritized communications according to an embodiment of the invention.

FIG. 6 is a flow chart depicting a method for implementing prioritized communications according to an embodiment of the invention.

FIG. 7 is a flow chart depicting a method for implementing prioritized communications according to an embodiment of the invention.

FIG. 8 is a flow chart illustrating a method for initializing an STT such that the STT is capable of operating in a DOCSIS mode, according to an embodiment of the present invention.

FIG. 9 is a flow chart depicting a method for implementing prioritized communications according to an embodiment of the invention.

### DETAILED DESCRIPTION OF PREFERRED EMBODIMENTS

Preferred embodiments of the present invention will be described below in the context of a set-top terminal (STT) that is communicatively coupled to a headend through a communications network. According to an embodiment of the invention, among others, a method for implementing prioritized communications includes receiving a first message from a first set-top terminal (STT), receiving a second message from a second STT, the second message identifying a second communication priority for the second STT, and responding to the second message prior to responding to the first message, responsive to the communication priority identified by the second message.

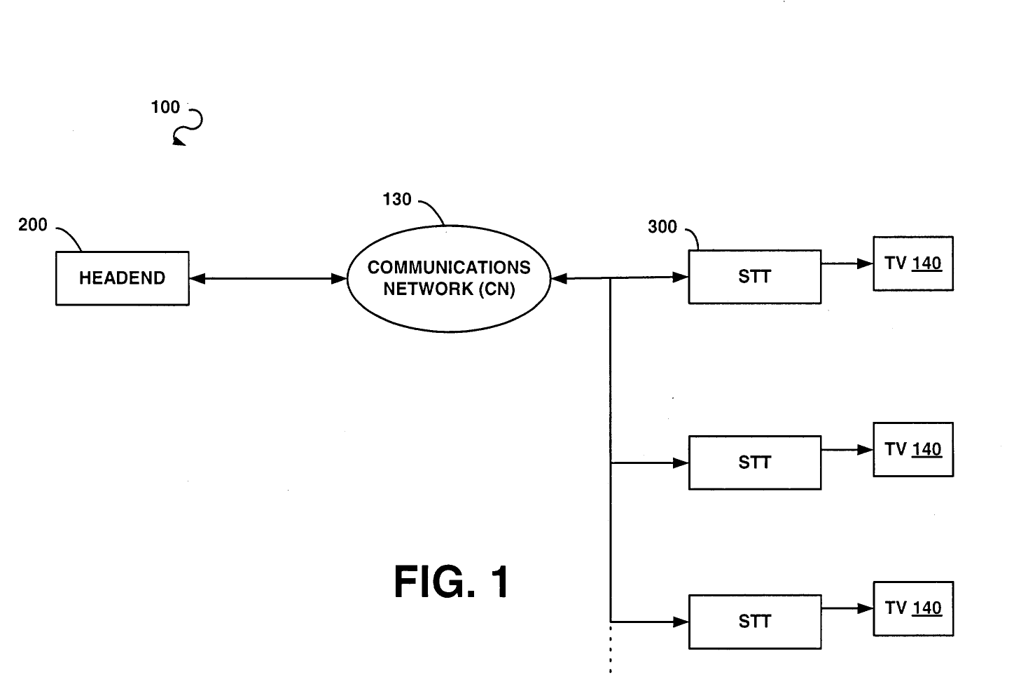

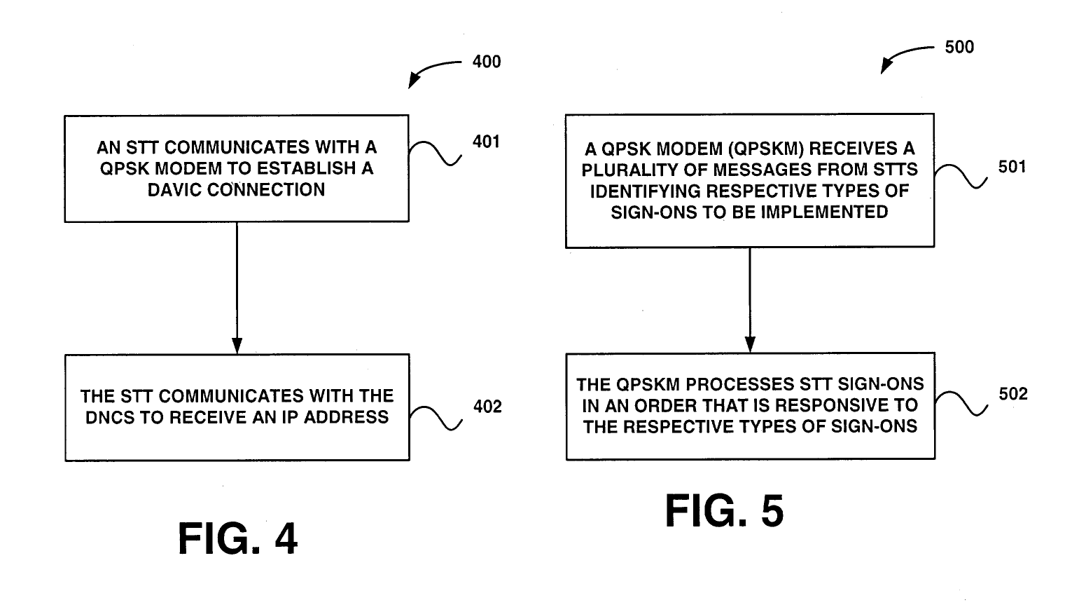

Below is a detailed description of the accompanying figures, which illustrate a preferred embodiment of the present invention: FIGS. 1-3 will provide examples of devices that may be used to implement prioritized communications, and FIGS. 4-9 will provide examples of methods for implementing prioritized communications. Note, however, that the invention may be embodied in many different forms and should not be construed as limited to the embodiments set forth herein. Furthermore, all examples given herein are intended to be non-limiting, and are provided in order to help clarify the description of the invention.

FIG. 1 is a block diagram illustrating a communications system 100 according to an embodiment of the present invention. In this example, the communications system 100 includes a headend 200 and an STT 300 that are coupled via a communications network (CN) 130. The CN 130 may be (or be part of), for example, a cable television network or a satellite television network, among others. The STT 300 is typically situated at a user's residence or place of business and may be a stand-alone unit or integrated into another device such as, for example, the television 140. The STT 300 receives signals (video, audio and/or other data) from the headend 200 through the CN 130. The STT 300 may also use the CN 130 to provide upstream messages to the headend 200. The headend 200 and the STT 300 cooperate to provide a user with television services via the television 140. The STT 300 may include a cable modem (not shown in FIG. 1) that provides communications services for one or more personal computers (PC), for a home network, and/or for software applications residing in the STT 300.

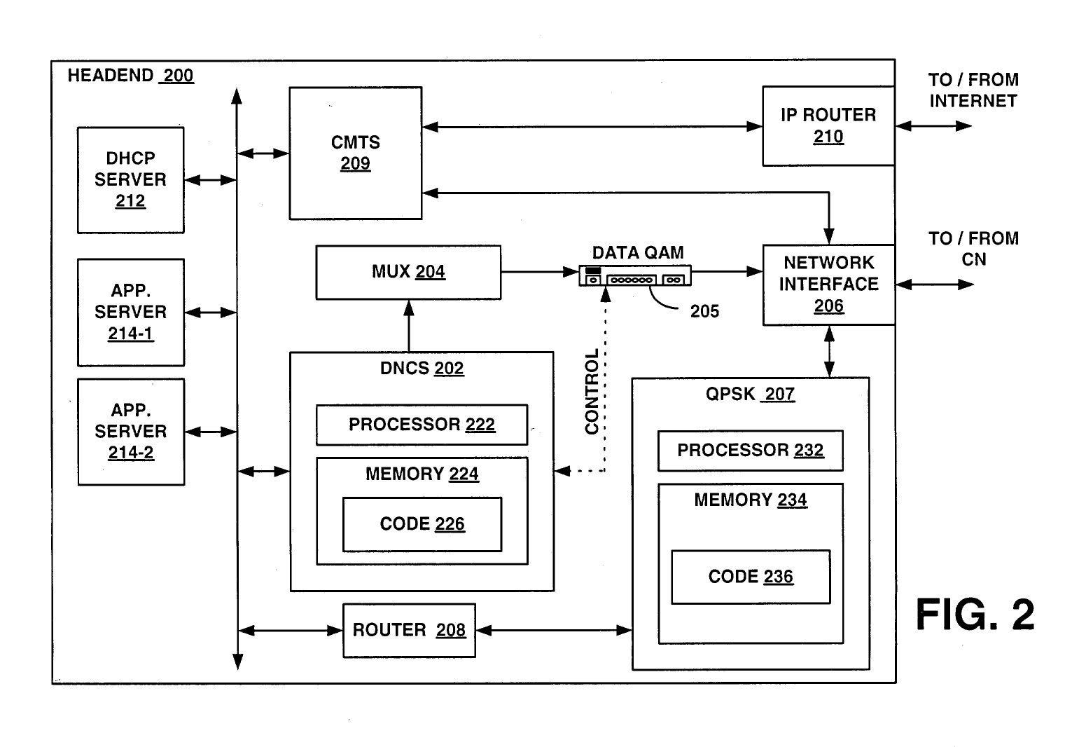

FIG. 2 is a simplified block diagram illustrating selected components of a headend 200 according to an embodiment of the invention. The headend 200 is merely illustrative and is not intended to imply any limitations upon the scope of the present invention. For example, in an alternative embodiment, the headend 200 may include additional and/or different components than those shown in FIG. 2. Furthermore, one or more of the components illustrated in FIG. 2 may reside outside the headend 200 (e.g., in another headend or in a hub that is located in the CN 130). The headend includes a plurality of application servers 214 (i.e., 214-1 and 214-2) that are responsible for providing data and/or software to STTs 300. The data and/or software that is provided by the application servers 214 may be transmitted using either a cable modem termination system (CMTS) 209, a quadrature phase shift keying (QPSK) modem 207, a Data quadrature amplitude modulation (QAM) modulator 205, and/or other transmission devices (not shown).

The Digital Network Control System (DNCS) 202 manages, monitors and controls the operation of STTs 300. The DNCS 202 includes a processor 222 that is configured to execute code 226 stored in memory 224. In one embodiment, the DNCS 202 functions as a session and resource manager (SRM) of a Digital Storage Media Command and Control (DSM-CC) environment. Therefore, the DNCS 202 may control the operation of STTs 300 through UNConfigIndication messages that comply with a DSM-CC standard such as, for example, the International Organization for Standardization/International Electrotechnical Commission (ISO/IEC) 13818-6 standard, which is hereby incorporated by reference in its entirety.

According to an embodiment of the invention, a UNConfigIndication message that is transmitted by the DNCS 202 to an STT 300 is configured to include, among other things, a data communication mode identifier (DCM-ID), a DNCS IP address, and a QPSK modulator identifier (QPSK-ID). In one embodiment, a DCM-ID is included in a UNConfigIndication message so that a DOCSIS-capable STT may identify the desired STT data communication mode. A data communication mode may be, for example, among others, a Digital Audio-Visual Council (DAVIC) mode that involves communicating using a DAVIC standard (e.g., the DAVIC 1.2 standard which is hereby incorporated by reference in its entirety). A data communication mode may also be, for example, among others, a Data Over Cable Service Interface Specifications (DOCSIS) mode that involves communicating using a DOCSIS standard (e.g., the DOCSIS 1.0 standard which is hereby incorporated by reference in its entirety). Furthermore, a data communication mode may involve using a plurality of communication standards including, for example, among others, DAVIC and DOCSIS standards.

In one implementation, the DNCS 202 uses a data insertion multiplexer 204 and a quadrature amplitude modulation (QAM) modulator 205 to insert in-band broadcast file system (BFS) data into an MPEG-2 transport stream that is broadcast to STTs 300.

The code 226 is configured to enable the DNCS 202 to implement prioritized communications. For example, if the DNCS 202 receives a plurality of messages (e.g., from QPSKMs 207) requesting information relating to respective STTs 300, the DNCS 202 (responsive to instructions contained in the code 226) may transmit a plurality of responses in an order that is responsive to the types of sign-ons being implemented by the respective STTs 300. With respect to STTs 300 that are implementing sign-ons having the same level of priority, the DNCS 202 may respond based on the order in which respective messages are received.

The DNCS 202 also receives a plurality of messages (e.g., UNConfigRequest messages) from STTs 300 requesting respective IP addresses and identifying respective types of sign-ons and/or sign-on priorities. The DNCS 202 responds to these messages (e.g., via UNConfigConfirm messages) in an order that is responsive to the respective types of sign-ons and/or sign-on priorities. With respect to STTs 300 that are implementing sign-ons having the same level of priority, the DNCS 202 may respond to the STTs 300 based on the order in which respective messages from the STTs 300 are received.

The QPSK modem 207 includes a processor 232 that is configured to execute code 236 stored in memory 234. The code 236 is configured to enable the QPSK modem 207 to implement prioritized communications. For example, if the QPSKM 207 receives a plurality of messages from STTs 300 identifying respective types of sign-ons and/or sign-on priorities, the QPSKM 207 (responsive to instructions contained in the code 236) may processes the STT 300 sign-ons in an order that is responsive to their respective types. The QPSKM 207 may process a sign-on by, for example, implementing ranging and power calibration for an STT 300, and by transmitting DAVIC connection parameters needed by the STT 300 to establish an interactive DAVIC connection.

In one possible implementation, a plurality of QPSK modems 207 may be responsible for transporting out-of-band IP (internet protocol) datagram traffic between the headend 200 and a plurality of STTs 300. Each QPSK modem 207 typically serves a certain geographical region. Although only one QPSK modem 207 is shown in FIG. 2, more QPSK modems 207 may be used depending on the number of STTs that are being served by the headend 200. The headend router 208 is responsible for routing upstream QPSK data to respective application servers 214 that are located at the headend 200, and for routing downstream QPSK data to respective QPSK modems 207.

A CMTS 209 may be used for providing a link between cable modems (CMs) contained in respective STTs 300 (FIG. 1) and an upstream network (e.g., the Internet (not shown)). The CMTS 209 receives an RF signal from a CM, demodulates the RF signal, and extracts Internet Protocol (IP) packets from the demodulated RF signal. The IP packets are then sent to an IP router 210 for transmission across the Internet, or elsewhere. When a CMTS 209 receives signals from the Internet via the IP router 210, it modulates the signals for transmission across the CN 130.

A DHCP (Dynamic Host Control Protocol) server 212 may be used to distribute IP addresses to CMs and to STT customer premises equipment (CPE) contained in respective STTs 300 (FIG. 1). A CM contained in an STT 300 may comprise components that are located in various areas of the STT 300. An STT CPE comprises an STT operating system (OS) and software applications that provide core STT functionality. Core STT functionality may include, for example, among others, the presentation of analog and/or digital television presentations (e.g., television channels), the presentation of interactive services (e.g., video-on-demand (VOD)), and the presentation of an interactive program guide (IPG).

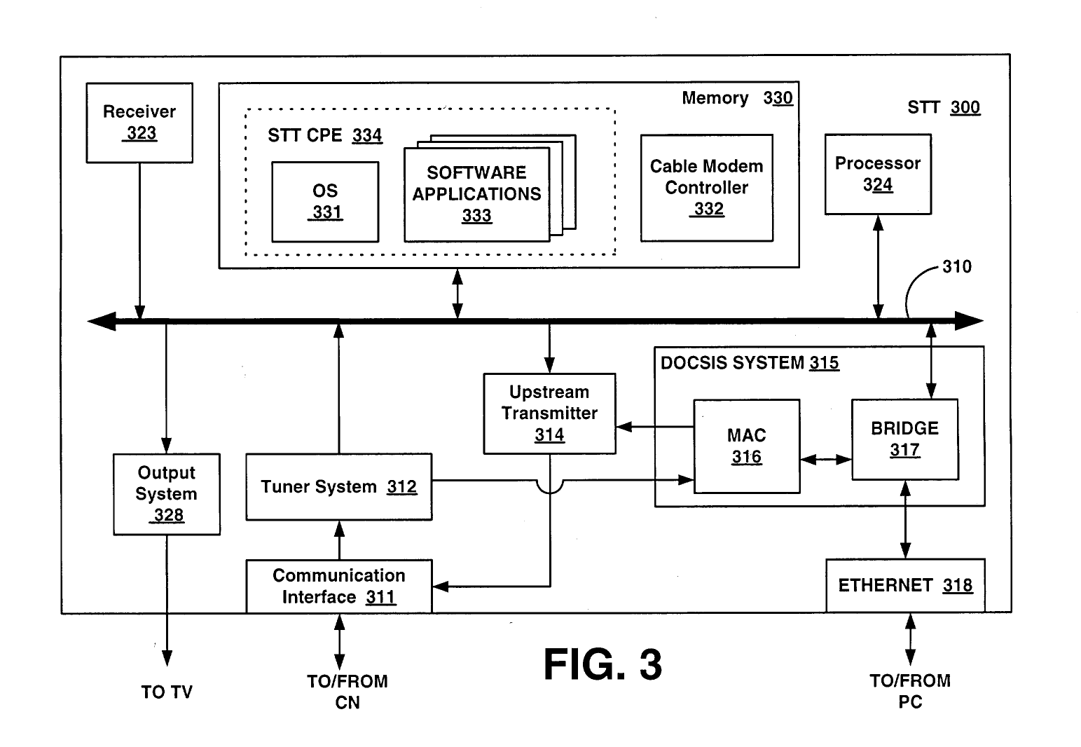

FIG. 3 is a block diagram depicting an STT 300 according to an embodiment of the present invention. The STT 300 may alternatively include additional and/or different components than the components depicted in FIG. 3. As shown in FIG. 3, the STT 300 includes the following: a communications interface 311 for receiving signals (video, audio and/or other data) from the headend 200 (FIG. 1), a tuner system 312 for extracting desired data from signals received by the communications interface 311, at least one processor 324 for controlling operations of the STT 300, an output system 328 for driving the television 140 (FIG. 1), an upstream transmitter 314 for transmitting upstream data to the headend 200, a DOCSIS system 315 for providing DOCSIS communications services, and an infra-red (IR) receiver 323 for receiving externally-generated user inputs. The processor 324, the memory 330, the output system 328, the receiver 323, and the DOCSIS system 315 are all coupled to a local interface 310. The local interface 310 may include, for example, but not limited to, one or more buses or other wired or wireless connections.

The tuner system 312 includes, in one implementation, a quadrature phase shift keying (QPSK) tuner for extracting out-of-band data and a quadrature amplitude modulation (QAM)/analog tuner for extracting audio and video data corresponding to a desired television channel. The QAM/analog tuner operates in a QAM mode to extract digital content, and operates in an analog mode to extract analog content. The tuner system 312 may be capable of demodulating, demultiplexing, and/or decoding extracted data. Alternatively, extracted data may be demodulated, demultiplexed, and/or decoded by a signal processing system (not shown) in the STT 300.

The DOCSIS system 315 includes, in one implementation, a DOCSIS MAC (media access control) component 316 and a DOCSIS bridge component 317. The DOCSIS MAC component 315 is responsible for formatting data received from the tuner system 312 and data that are forwarded to the upstream transmitter 314. The DOCSIS bridge component 317 routes data packets to their respective destinations. The DOCSIS system 315 is controlled by a cable modem controller 332, which is a software application residing in memory 330. In one embodiment, the cable modem controller 332, the DOCSIS system 315, the upstream transmitter 314, and a QAM tuner (not shown) in the tuner system 312 collectively function as a cable modem.

The processor 324 is preferably a hardware device for executing software, particularly that stored in memory 330. The processor 324 can be a custom made or commercially available processor, a central processing unit (CPU), an auxiliary processor among several processors associated with the STT 300, a semiconductor based microprocessor (in the form of a microchip or chip set), or generally any device for executing software or other instructions. Preferably, when the STT 300 is in operation, the processor 324 is configured to execute software stored within the memory 330, to communicate data to and from the memory 330, and to generally control operations of the STT 300 pursuant to the software.

The memory 330 may include any one or combination of volatile memory elements (e.g., random access memory (RAM), dynamic RAM (DRAM), static RAM (SRAM), synchronous DRAM (SDRAM), magnetic RAM (MRAM), etc.) and nonvolatile memory elements (e.g., read only memory (ROM), hard drive, tape, compact disk ROM (CD-ROM), etc.), among others. Moreover, the memory 330 may incorporate electronic, magnetic, optical, and/or other types of storage media. Note that the memory 330 can have a distributed architecture, where various components are situated remotely from one another, but can be accessed by the processor 324.

The software in memory 330 may include one or more separate programs, each of which comprises an ordered listing of executable instructions for implementing logical functions. In the example of FIG. 3, the software in the memory 330 includes an operating system (OS) 331 that controls the execution of other software, such as the cable modem controller 332 and the software applications 333. The OS 331 also provides scheduling, input-output control, file and data management, memory management, and communication control and related services. The software applications 333 and the OS 331, which provide core STT functionality, are part of what is termed “STT CPE” 334. In a preferred implementation, the STT CPE 334 uses an RF MAC address whereas the DOCSIS system 315 uses an Ethernet MAC address. The RF MAC address and the Ethernet MAC address may be assigned to the STT at the time that the STT is manufactured.

An STT 300 can receive broadcast STT data over either a DAVIC or a DOCSIS channel. When the STT 300 is powered up, it may search the DAVIC QPSK forward path spectrum (70-130 MHz) and the DOCSIS QAM forward path spectrum (88-870 MHz) until the STT 300 locates broadcast STT data. The STT 300 can then find a UNConfigIndication message in the broadcast STT data and can examine the DCM-ID (data communication mode identifier) contained in such message to determine the desired communication mode.

The STT 300 may use, for example, a DAVIC channel (i.e., a communication channel that carries data transmitted in accordance with DAVIC specifications) for receiving out-of-band (OOB) broadcast data and conditional access (CA) data (hereinafter collectively referred to as “broadcast and CA data”). Furthermore, the STT 300 may establish an interactive DAVIC connection that can be used by the STT CPE 334 to receive and transmit unicast data. The CA data may include, for example, among others, global broadcast authentication messages (GBAMs) and/or entitlement management messages (EMMs).

The OOB broadcast data comprises non audio and/or video (A/V) data that are broadcast to STTs 300. The OOB broadcast data may be used by the STTs 300 to help provide STT functionality to a user, and may include, for example, among others, schedules of television services that are to be broadcast to the STTs 300. The schedules for television services may be presented to a user by an STT 300 as part of an interactive program guide (IPG) presentation. The OOB broadcast data may also include, for example, UNConfigIndication messages, UNDownload messages, and/or UNPassthru messages that comply with a DSM-CC standard. Unicast data, on the other hand, are data that are unicast to or from a single STT, and may include, for example, among others, unicast UNPassthru messages from the DNCS 202 to an STT. In one embodiment, among others, the STT 300 may receive and/or transmit data that are formatted and modulated in accordance with a DAVIC standard (e.g., DAVIC 1.2) in response to the STT 300 receiving a DAVIC DCM-ID.

Alternatively, the STT 300 may establish an interactive DOCSIS connection that can be used by the STT CPE 334 to receive unicast, broadcast and CA data, and to transmit unicast data. In yet another implementation, an STT may use a DAVIC channel for receiving broadcast and CA data, and may establish an interactive DOCSIS connection that can be used by the STT CPE 334 to receive and transmit unicast data.

An STT 300 signs-on to a subscriber network by establishing a media access control (MAC) layer connection, and by optionally performing DSM-CC registration with the DNCS 202. A MAC layer connection (e.g., DAVIC-based or DOCSIS-based) is a two-way connection at the MAC communication layer. In one possible implementation, among others, a DAVIC-based MAC layer connection may be considered established when a “Reservation ID Assignment Message” is received by the STT 300. On the other hand, a DOCSIS-based MAC layer connection may be considered established when a “Registration Response Message” has been received by the STT 300.

After an STT 300 boots, it may select a random time in the future (e.g., between 2 and 10 hours after booting) for signing-on. The 2-10 hour interval is referred to as the ‘slow boot’ or ‘background sign-on’ window. At the randomly selected time, if the STT 300 has not yet signed-on, then it can attempt to do so. If a sign-on attempt is not successful, then the STT 300 can execute a back-off algorithm and try to sign-on at a future time.

Having STTs 300 signed-on allows system operators to monitor a network's ability to provide interactive services. An immediate sign-on (also referred to as a higher priority sign-on) is designed to ensure that an interactive connection is quickly made available to a subscriber who is actively using an STT 300. On the other hand, a background sign-on (also referred to as a lower priority sign-on) is designed to ensure that an STT signs-on at some future time. Examples of circumstances leading to a background sign-on by an STT 300 may include, among others:

1) Power outage: The loss and re-application of AC power to an STT 300 can cause a reboot operation. After the STT 300 reboots, it will be powered ‘OFF’ and will perform a background sign-on at a randomly selected time in the future.

2) QPSKM rebooting: When a QPSKM 207 reboots, all of its STT 300 connection records are erased. The STT 300, however, is unaware of any change other than a brief interruption of the forward path. The STT 300, if it had been signed-on prior to the rebooting-up of the QPSK, will send an Idle Message to the QPSK. Upon receiving an Idle Message from a now-unknown STT 300, the QPSKM 207 will send a ‘Reprovision Message’ to the STT 300, causing it to perform a background sign-on.

3) Software download: After an STT 300 has completed a software download, it will reboot and perform a background sign-on at a randomly selected time in the future.

4) Communication Interruption: If there is an interruption in the RF forward or reverse path for greater than a predetermined time period (e.g., greater than 4 minutes), then an STT 300 may perform a background sign-on to re-establish an interactive connection.

5) VCR timer: If a VCR timer expires and the STT 300 has not signed-on, the STT 300 may attempt a background sign-on.

An immediate sign-on (i.e., a higher priority sign-on) is performed by an STT 300 in response to a user attempt to access an STT function that requires an interactive connection (if such interactive connection does not currently exist). Examples of STT functions that may require an interactive connection include, for example, among others, video-on-demand (VOD), e-mail, Internet browsing, etc.

FIG. 4 is a flow chart depicting a DAVIC sign-on method 400 according to an embodiment of the invention. In step 401, an STT 300 communicates with a QPSK modem (QPSKM) 207 to establish a DAVIC connection. For example, the STT 300 and the QPSKM 207 communicate in order to implement ranging and power calibration. The QPSKM 207 may also communicate with a DNCS 202 to determine the STT's 300 administrative state (e.g., whether the STT 300 is authorized to establish a DAVIC connection). The QPSKM 207 can finalize a 2-way DAVIC connection for the STT 300 by transmitting DAVIC connection parameters to the STT 300. The STT 300 then communicates with the DNCS 202 to receive an IP address, as indicated in step 402. For example, the STT 300 may transmit a UNConfigRequest message to the DNCS 202, and the DNCS 202 may respond by transmitting a UNConfigConfirm message comprising an IP address.

FIG. 5 is a flow chart depicting a prioritized communication method 500 according to an embodiment of the invention. In step 501, a QPSKM 207 receives a plurality of messages from STTs 300 identifying (e.g., in their respective headers) respective types of sign-ons and/or sign-on priorities. These plurality of messages may be, for example, ‘signon response messages’ that are transmitted to the QPSKM 207 in response to respective ‘signon request messages’ in accordance with a DAVIC specification. A sign-on may be identified, for example, as ‘background’ or ‘immediate,’ where an immediate sign-on signifies a higher level or priority than a background signon. A sign-on or sign-on priority may be identified using any identification means including for example, numerals, letters, and/or other characters. Furthermore, there may be more than two levels of sign-on priorities. The QPSKM 207 then processes STT 300 sign-ons in an order that is responsive to the respective types of sign-ons, as indicated in step 502. For example, the QPSKM 207 may implement sign-ons having a higher sign-on priority prior to implementing sign-ons having a lower sign-on priority. The QPSKM 207 may process a sign-on by, for example, implementing ranging and power calibration for an STT 300, and by transmitting DAVIC connection parameters needed by the STT 300 to establish an interactive DAVIC connection.

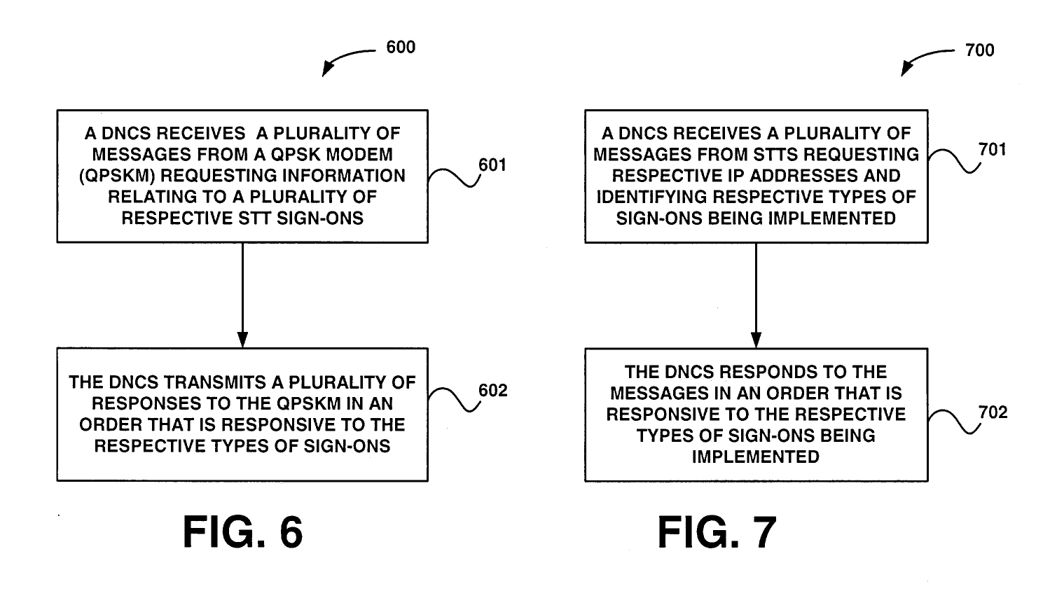

FIG. 6 is a flow chart depicting a prioritized communication method 600 according to an embodiment of the invention. In step 601, a DNCS 202 receives a plurality of messages from one or more respective QPSK modems 207. Each of these messages requests information relating to an STT 300 implementing a certain type of sign-on. The information requested by a message from a QPSKM 207 may be, for example, the administrative state of an STT 300 (e.g., whether the STT 300 is authorized to establish a DAVIC connection). The DNCS 202 then transmits a plurality of responses to the QPSKM(s) 207 in an order that is responsive to the types of sign-ons being implemented by the respective STTs 300, as indicated in step 602. For example, the DNCS 202 may respond to the QPSKM(s) 207 regarding STTs 300 having a higher sign-on priority prior to responding to the QPSKM(s) 207 regarding STTs 300 having a lower sign-on priority.

FIG. 7 is a flow chart depicting a prioritized communication method 700 according to an embodiment of the invention. In step 701, a DNCS 202 receives a plurality of messages from STTs 300 requesting respective IP addresses and identifying (e.g., in their respective headers) respective types of sign-ons and/or sign-on priorities. Each of the plurality of messages may be, for example, a UNConfigRequest message that is configured in accordance with a DSM-CC specification. The DNCS 202 then responds to the messages in an order that is responsive to the respective types of sign-ons and/or sign-on priorities, as indicated in step 702. For example, the DNCS 202 may respond to STTs having a higher sign-on priority prior to responding to STTs having a lower sign-on priority. Furthermore, the DNCS 202 may respond to a UNConfigRequest message by, for example, transmitting a UNConfigConfirm message that contains an IP address that can be used by a respective STT 300.

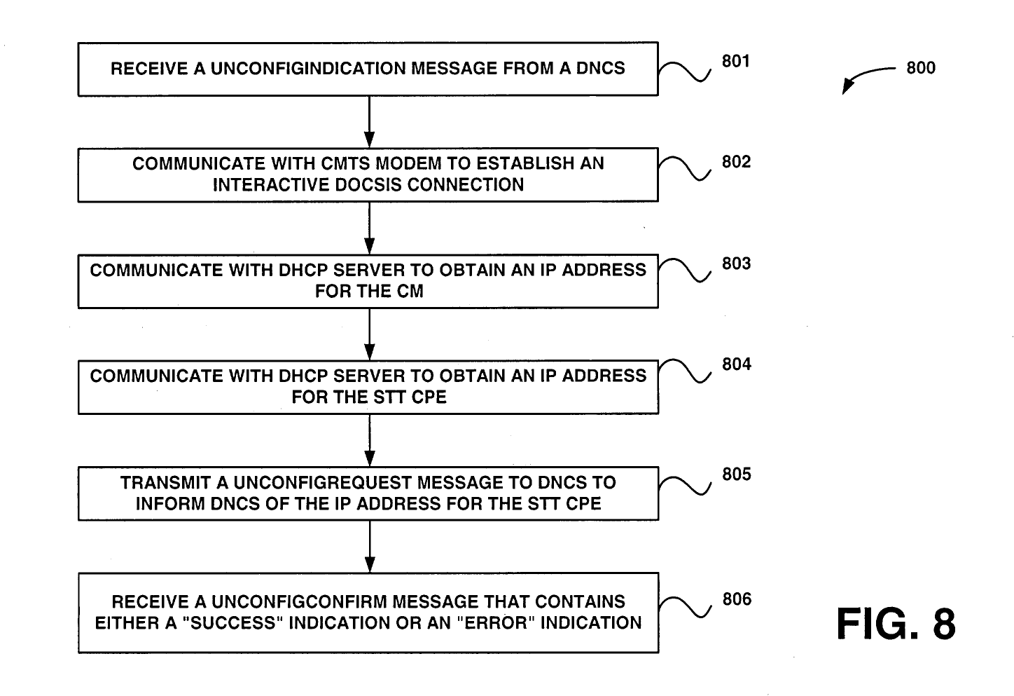

FIG. 8 is a flow chart illustrating a DOCSIS sign-on method 800, according to an embodiment of the invention. As shown in step 801, the STT 300 receives from the DNCS 202 a UNConfigIndication message. In response to receiving the UNConfigIndication message, the STT communicates with the CMTS 209 (FIG. 2) to establish an interactive DOCSIS connection, as indicated in step 802. The STT 300 then communicates with the DHCP server 212 (FIG. 2) to obtain an IP address for the cable modem within the STT 300, as indicated in step 803. The STT 300 also communicates with the DHCP server 212 to obtain an IP address for the STT CPE 334, as indicated in step 804.

After obtaining a CPE IP address, the STT 300 transmits a UNConfigRequest message to the DNCS 202 to inform the DNCS 202 of the CPE IP address, as indicated in step 805. An STT 300 may also include its CPE MAC address and QPSK modulator ID in the UNConfigRequest message.

Finally, in step 806, the STT 300 receives a UNConfigConfirm message from the DNCS 202 that contains either a “success” indication or an “error” indication. A success indication permits the STT 300 to use the IP address for the STT CPE, whereas an error indication denies the STT 300 permission to use the IP address for the STT CPE.

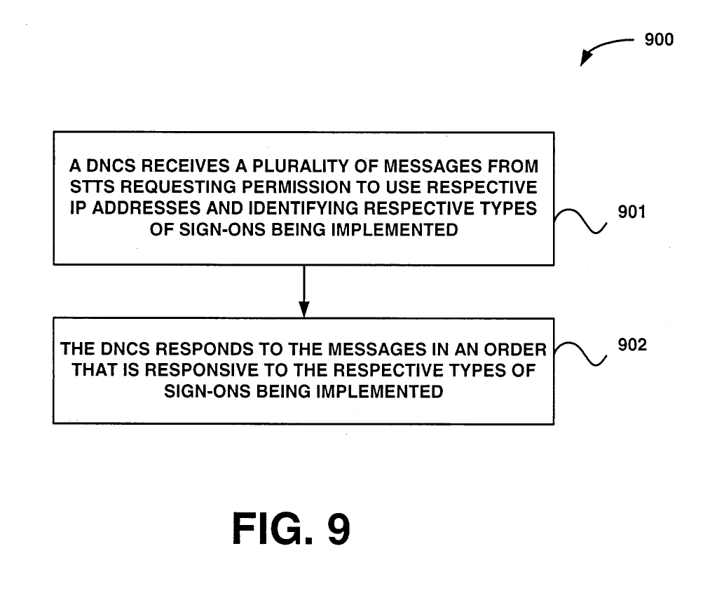

FIG. 9 is a flow chart depicting a prioritized communication method 900 according to an embodiment of the invention. In step 901, a DNCS 202 receives a plurality of messages from STTs 300 requesting permission to use respective IP addresses, and identifying respective types of sign-ons and/or sign-on priorities. The plurality of messages received form the STTs 300 may be, for example, UNConfigRequest messages. The DNCS 202 then responds to the messages in an order that is responsive to the respective types of sign-ons and/or sign-on priorities, as indicated in step 902. The DNCS 202 may respond to a message from an STT 300 by transmitting, for example, a UNConfigConfirm message.

The blocks shown in FIGS. 4-9 represent modules, segments, or portions of code which include one or more executable instructions for implementing specific logical functions or steps in a process. In an alternative embodiment, functions or steps depicted in FIGS. 4-9 may be executed out of order from that shown or discussed, including substantially concurrently or in reverse order, depending on the functionality involved, as would be understood by those of ordinary skill in the art.

The functionality provided by the methods illustrated in FIGS. 4-9 can be embodied in any computer-readable medium for use by or in connection with a computer-related system (e.g., an embedded system such as a modem) or method. In the context of this document, a computer-readable medium is an electronic, magnetic, optical, semiconductor, or other physical device or means that can contain or store a computer program or data for use by or in connection with a computer-related system or method. Furthermore, the functionality provided by the methods illustrated in FIGS. 4-9 can be implemented through hardware (e.g., an application specific integrated circuit (ASIC) and supporting circuitry) or a combination of software and hardware.

It should be emphasized that the above-described embodiments of the present invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and present invention and protected by the following claims. In addition, the scope of the present invention includes embodying the functionality of the preferred embodiments of the present invention in logic embodied in hardware and/or software-configured mediums.

What is claimed is:

1. A method for communicating with a set-top terminal, the method comprising:
receiving a first message from a first set-top terminal (STT);
receiving a second message from a second STT, the second message identifying a communication priority for the second STT; and
responding to the second message prior to responding to the first message, responsive to the communication priority identified by the second message.

2. The method of claim 1, wherein the method is implemented by a QPSK modem.

3. The method of claim 2, wherein the first message and the second message are sign-on messages.

4. The method of claim 1, wherein the method is implemented by a digital network control system (DNCS).

5. The method of claim 4, wherein the first message and the second message request registration with the DNCS.

6. The method of claim 1, wherein the communication priority identified by the second message is greater than a communication priority identified by the first message.

7. The method of claim 1, further comprising:
enabling the second STT to establish a MAC layer connection prior to enabling the first STT to establish a MAC layer connection, responsive to the communication priority identified by the second STT.

8. The method of claim 1, further comprising:
enabling communication calibration for the second STT prior to enabling communication calibration for the first STT, responsive to the sign-on priority identified by the second message.

9. The method of claim 8, wherein the communication calibration for the second STT comprises ranging and power calibration.

10. A method comprising:
receiving by a digital network control system (DNCS) a first message from a first modem, and a second message from a second modem, the second message identifying a sign-on priority for a second STT;
responding by the DNCS to the second message prior to responding to the first message, responsive to the sign-on priority identified by the second message.

11. The method of claim 10, further comprising:
determining by the DNCS that the sign-on priority identified by the second message is greater than a sign-on priority identified by the first message.

12. The method of claim 10, wherein the first message requests an administrative status for the first STT, and the second message requests an administrative status for the second STT.

13. The method of claim 12, wherein the DNCS responds to the first message by transmitting a message containing the administrative status for the first STT, and responds to the second message by transmitting a message containing the administrative status for the second STT.

14. A method for communicating with a set-top terminal, the method comprising:
receiving a first message from a first set-top terminal (STT);
receiving a second message from a second STT, the second message identifying a type of sign-on to be accomplished for the second STT; and
responding to the second message prior to responding to the first message, responsive to the type of sign-on identified by the second message.

15. The method of claim 14, wherein the method is implemented by a QPSK modem.

16. The method of claim 15, wherein the first message and the second message are sign-on messages.

17. The method of claim 14, wherein the method is implemented by a digital network control system (DNCS).

18. The method of claim 17, wherein the first message and the second message request registration with the DNCS.

19. The method of claim 14, wherein the type of sign-on identified by the second message is different than a type of sign-on identified by the first message.

20. The method of claim 14, further comprising:
enabling the second STT to establish a MAC layer connection prior to enabling the first STT to establish a MAC layer connection, responsive to the type of sign-on identified by the second STT.

21. The method of claim 14, further comprising:
enabling communication calibration for the second STT prior to enabling communication calibration for the first STT, responsive to the type of sign-on identified by the second message.

22. The method of claim 21, wherein the communication calibration for the second STT comprises ranging and power calibration.

23. A method for communicating with set-top terminals, the method comprising:
receiving a plurality of messages from a plurality of respective set-top terminals (STTs), each of the plurality of messages identifying a communication priority; and
responding to plurality of messages in an order that is responsive to the communication priorities identified by the plurality of messages.

24. The method of claim 23, wherein the method is implemented by a QPSK modem.

25. The method of claim 24, wherein the plurality of messages are sign-on messages.

26. The method of claim 23, wherein the method is implemented by a digital network control system (DNCS).

27. The method of claim 26, wherein the plurality of messages request registration with the DNCS.

28. The method of claim 23, further comprising:
enabling the plurality of STTs to establish respective MAC layer connections in an order that is responsive to the communication priorities identified by the plurality of messages.

29. The method of claim 23, further comprising:
enabling communication calibrations for the plurality of STTs in an order that is responsive to the communication priorities identified by the plurality of messages.

30. A system for communicating with a set-top terminal, the system comprising:
logic configured to examine a first message received from a first set-top terminal (STT),
logic configured to examine a second message received from a second STT, the second message identifying a communication priority for the second STT, and
logic configured to cause a transmission of a response to the second message prior to causing a transmission of a response to the first message, responsive to the communication priority identified by the second message.

31. The system of claim 30, wherein the system comprises a QPSK modem.

32. The system of claim 31, wherein the first message and the second message are sign-on messages.

33. The system of claim 30, wherein the system comprises a digital network control system (DNCS).

34. The system of claim 33, wherein the first message and the second message request registration with the DNCS.

35. The system of claim 30, wherein the communication priority identified by the second message is greater than a communication priority identified by the first message.

36. The system of claim 30, further comprising:
logic configured to enable the second STT to establish a MAC layer connection prior to enabling the first STT to establish a MAC layer connection, responsive to the communication priority identified by the second STT.
